(19) United States
(12) Patent Application Publication
(10) Pub. No.: US 2004/0026309 A1
(43) Pub. Date: Feb. 12, 2004

(54) Filtration cloth for solid-liquid systems

(75) Inventors: Kimmo Jarvinen, Tampere (FI); Aarne-Matti Heikkila, Tampere (FI)

Correspondence Address: OLIFF & BERRIDGE, PLC, P.O. BOX 19928, ALEXANDRIA, VA, 22320, US

(73) Assignee: TAMFELT OYJ ABP, Tampere (FI)

(21) Appl. No.: 10/637,636

(22) Filed: Aug. 11, 2003

Related U.S. Application Data
(63) Continuation of application No. PCT/FI01/01140, filed on Dec. 20, 2001.

(30) Foreign Application Priority Data
Mar. 2, 2001 (FI) 20010414

(51) Int. Cl. B01D 39/08

(52) U.S. Cl. 210/243; 210/504; 210/505; 210/506; 210/507

(57) ABSTRACT

A solid-liquid filtration cloth comprising a base fabric woven from polymer yarns. After the weaving, the base fabric has been treated by a polymer material, which has better electric conductivity than the polymer yarns of the base fabric. The polymer treatment is carried out by means of a polyaniline solution or a polypyrrole solution, for instance. After the polymer treatment, at least the yarns on the surface of the base fabric comprise a coating of an electrically conductive polymer.

### FIELD OF THE INVENTION

The invention relates to a solid-liquid filtration cloth comprising a base fabric woven from machine direction and cross direction yarns of a polymer material.

### BACKGROUND OF THE INVENTION

For example in mining industry, in refinement of metals, chemical industry, and food productional and pharmaceutical processes there is a need for solid-liquid filtration for separating liquid and solid particles from a mixture of solids and liquid. Filter apparatuses with different operating principles and properties have been developed for solid-liquid filtration. Known apparatuses include vertically and horizontally placed chamber filters, belt filters, double belt press filters, horizontal filters, and disc and drum filters. In all these apparatuses, filtration is based on separating the liquid phase and the solid phase at least partly by means of a pressure difference. In solid-liquid filters, the filter surface of the filter is provided with a filtration cloth, which operates as a filtering layer. In some filter apparatuses, the filtration cloth is moved during filtration, controlled by suitable rollers either continuously or in cycles. Furthermore, for example in disc and drum filters a filter surface provided with a filtration cloth is moved in a basin containing a mixture to be processed, so that solids are caught on the surface of the cloth. The filter surface is moved with respect to doctor blades or the like, which guide the solids accumulated on the outer surface of the filtration cloth away from the cloth. Moving of the filtration cloth under the control of the rollers according to the first principle and scraping of the cloth surface by the doctor blades according to the second principle result in frictional electricity generated in the filtration cloth in each case. Since filtration cloths are made of yarns of polymer material, they act as insulators, wherefore the frictional electricity accumulates in the filtration cloth and forms a static electric charge. This charge can be so high that it can be discharged via the surrounding air, producing sparks. Sparking caused by static electricity is dangerous when a filter apparatus is used to process highly volatile sludge, which forms explosive gases.

Furthermore, in addition to mechanical solid-liquid filtration the prior art teaches electrolytic solid-liquid apparatuses used for example in the mining industry to refine metals. In an electrolytic process, the filtration cloth forms a flow resistance between a cathode and an anode chamber. The operating mechanism of a filtration cloth during electrolysis is not accurately known, but in practice it has been found out that the filtration cloth significantly improves the operation and efficiency of the electrolytic process. In a process for refining metals, the feed solution is a saline solution of a precious metal, such as silver, nickel, manganese or the like. The feed solution is supplied to an electric field, and the desired component is reduced at the cathode while undesirable components are guided via the anode chamber to removal of impurities and further to solution circulation. The present filtration cloths used in electrolytic appliances are woven from polyolefins, polypropylene, polyamide and similar yarns of polymer material. Physically such materials are hydrophobic insulators, wherefore also the filtration cloths woven therefrom are hydrophobic. Furthermore, filtration cloths woven from polymer yarns are electric insulators. For these reasons, the present filtration cloths with low conductivity form an additional flow and electricity resistance, which disadvantageously increases the consumption of energy during electrolysis.

### BRIEF DESCRIPTION OF THE INVENTION

An objective of the present invention is to provide a new woven filtration cloth with better conductivity for solid-liquid filtration.

The filtration cloth according to the invention is characterized in that the base fabric has been treated after the weaving by a polymer material, which has better electric conductivity than the yarns of the base fabric, which comprise a coating of said electrically conductive polymer material at least on one side of the base fabric.

A basic idea of the invention is that the filtration cloth comprises a base fabric woven from polymer yarns and treated after weaving at least on one side with a polymer that has higher electric conductivity than the polymer yarns of the base fabric. A layer of polymer material with higher electric conductivity is thus formed on the surfaces of the yarns in the base fabric. After the weaving, the base fabric comprises openings, which become smaller when an additional layer is formed on the surface of the yarns from conductive polymer. The structure of the filtration cloth thus becomes denser, so that the cloth has lower permeability after the polymer treatment than before it. A denser filtration cloth than previously also enables separation of finer solid partides from liquid. Furthermore, the small size of the openings in the filtration cloth and the improved conductivity thereof result in increased hydrophilicity of the cloth compared to the present solid-liquid filtration cloths. Due to the hydrophilicity, liquid can pass through the filtration cloth as desired despite the small size of the openings in the cloth. Also, since the electrically conductive polymer makes the filtration cloth more conductive, the frictional electricity generated in mechanical solid-liquid apparatuses can be conducted out of the cloth, thus avoiding safety risks and other drawbacks resulting from static electric charges. In electrolytic solid-liquid filtration, the conductive filtration cloth according to the invention acts as an electrically conductive element between the electrodes and not as insulation, as previously. The consumption of energy of the electrolytic process can thus be reduced by means of the filtration cloth according to the invention. Furthermore, due to the inner structure of the filtration cloth, the cloth may be provided with a permanent electrical charge, wherefore the cloth can be used as an ion selective screen during electrolysis.

The filtration cloth according to the invention also may have higher resistance to abrasion, which gives it a longer service life. The higher resistance to abrasion results from the fact that the yarns of the base fabric, which receive loads directed at the filtration cloth, are protected by the polymer material. Furthermore, for example polyaniline has a substantially lower coefficient of friction than the yarn materials used most often in weaving of the base fabric. Another factor improving the resistance to abrasion is that the polymer treatment makes the surface of the filtration cloth denser and thus smoother.

Yet another advantage may be that solid particles are not able to penetrate through the small openings of the dense filtration cloth into the cloth itself, wherefore the cloth is not easily clogged. Such a filtration cloth has a long service life.

### BRIEF DESCRIPTION OF THE FIGURES

The invention will be described in more detail in the accompanying drawings, in which

FIG. 1 shows schematically a base fabric of a filtration cloth according to the invention before polymer treatment, viewed in the direction of weft yarns,

FIG. 2a shows schematically the filtration cloth according to FIG. 1 after the polymer treatment, viewed in the direction of weft yarns,

FIGS. 2b and 2c schematically show cross-sections of yarns after the polymer treatment,

FIGS. 3 to 5 schematically show application of the filtration cloth according to the invention in a disc filter,

FIG. 6 schematically shows application of the filtration cloth according to the invention in a drum filter, and

FIG. 7 schematically shows application of the filtration cloth according to the invention in an electrolytic process.

### DETAILED DESCRIPTION OF THE INVENTION

The invention is shown in a simplified form in the figures. Like reference numerals refer to like parts in the figures.

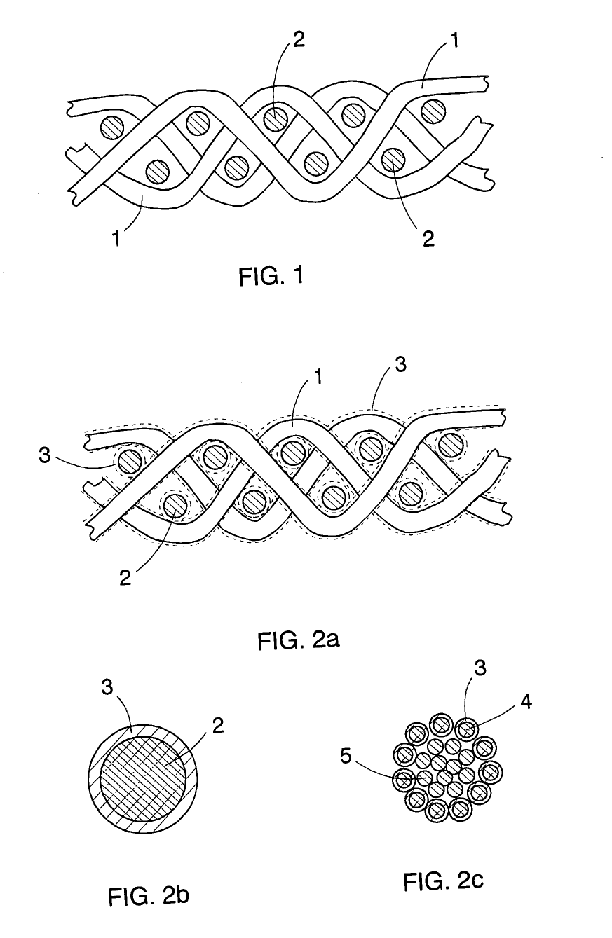

FIG. 1 shows the structure of a woven base fabric, which comprises machine direction warp yarns 1 and cross direction weft yarns 2. The material of the warp and weft yarns can be for example polyolefin, polypropylene, polyamide or some other polymer material suitable for the purpose. The yarns can be either monofilament, multifilament, film or spun yarns. The base fabric can also comprise different types of yarns to provide a desired combination. A base fabric of a filtration cloth according to the invention may be formed through weaving by means of a weave structure known per se. The base fabric shown in the figure has two layers. In the simplest form a base fabric has only one layer, but on the other hand it can also comprise more than two layers. A base fabric is woven since woven structures are able to withstand the forces directed at the filtration cloth during solid-liquid filtration. Due to matters related to weaving technology, it is difficult to make even denser filtration cloths than previously. On the contrary, the non-woven technique enables the formation of very dense structures, but unfortunately a drawback of non-woven structures is poor mechanical resistance particularly in wet conditions, wherefore they are seldom suitable for solid-liquid filtration.

FIG. 2a shows the situation after the base fabric of FIG. 1 has been treated by an electrically conductive polymer. For the sake of clarity, the figure shows, by a broken line, a polymer material forming a coating 3 on the surface of yarns 1, 2 of the base fabric. The size of the openings in the filtration cloth subjected to polymer treatment may vary between 0.2 and 50 micrometers, preferably between 1 and 5 micrometers.

FIG. 2b shows a cross-section of a single monofilament yarn separated from a treated base fabric. The electrically conductive polymer has formed a thin coating 3 on the surface of the yarn 2.

FIG. 2c shows a cross-section of a single multifilament yarn separated from a treated base fabric. The electrically conductive polymer has penetrated a distance into the yarn from between the multifilaments and formed a thin coating 3 on the surface of at least the outermost multifilaments 4 in the yarn. Depending on the manner of treatment, the polymer material can form either only a thin coating on the yarn's outer circumference, or it can even penetrate substantially through the entire yarn and form a coating also on the surface of the inner multifilaments 5.

### EXAMPLE 1

A base fabric was woven from polyester multifilament yarns with a tex value of 110. The weave structure was a plain weave with a warp density of 260 yarns/10 cm and a weft density of 140 yarns/10 cm. After the weaving, the measured water permeability of the base fabric was 70 l/m²/h (150 mm of water column) and the surface resistance thereof was 4*10¹² ohm (according to standard SFS-EN 1149-1) and the water absorption time of the base fabric was 20 seconds. After the weaving the base fabric was treated with a polyaniline solution. After the polymer treatment, the measured water permeability of the base fabric was 32 l/m²/h, the surface resistance was 6*10⁶ ohm, and the water absorption time was 2 seconds. According to the measurements, the polymer treatment increased the weight of the filtration cloth only by 2%. Furthermore, after the polymer treatment the abrasion resistance of the filtration cloth was about 1000 revolutions higher than that of an untreated base fabric, measured by the Martindale abrasion test (abrasive paper P360 Wurth, pressure 12 kPa). The results show that the polymer treatment has, for example, made the filtration cloth denser, since the water permeability was clearly lower after the treatment. Also, the filtration cloth has lower electric resistance, which results from a low but residual electric charge generated in the filtration cloth due to the polymer treatment. As a result of the electric charge, the filtration cloth becomes more hydrophilic, which is evident for example from the shorter water absorption time and a wider contact angle.

The polymer treatment can be carried out for example by means of a polyaniline solution according to U.S. Pat. No. 5,567,356. Other similar substances, such as a polypyrrole-based solution, can also be used. The treatment can be carried out by immersing the base fabric in a bath containing an electrically conductive polymer solution. Polymer treatment can alternatively be implemented by spraying, brushing, spreading by a roller, or in some other manner of treatment known per se in the field. The essential factor in the treatment is that the conductive polymer material forms a coating on the surface of the yarns provided on the outer surface of the filtration cloth, preferably through the entire structure of the base fabric.

The description below relates to a few examples of typical solid-liquid apparatuses and processes, where a filtration cloth according to the invention can be applied advantageously.

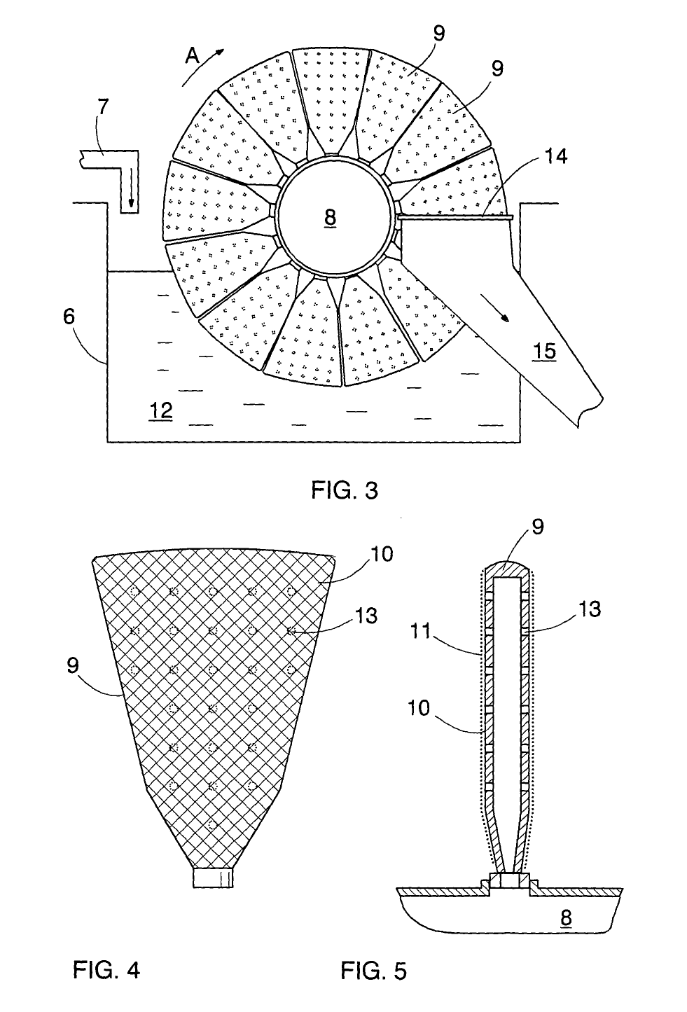

FIG. 3 shows the principle of a typical disc filter. The disc filter comprises a basin 6, to which a solution of solids and liquid is conducted for treatment from a feed channel 7. The disc filter comprises a tubular frame part 8 rotated around a horizontal axis and comprising on its outer circumference several substantially triangular sector elements 9 arranged adjacently to one another so that the sector elements form a disc-like structure. As shown in FIGS. 4 and 5, triangular, perforated side surfaces 10 of the sector elements 9 act as filter surfaces. A filtration cloth 11 is arranged against the filter surface 10 of the sector element to act as the actual filtering layer. The disc filter is rotated in direction A in a mixture 12 contained in the basin 6 while a negative pressure is generated inside the sector element. Some of the liquid is thus able to pass through the filtration cloth and the openings 13 provided on the filter surface to enter the sector element 9. The solids remain on the surface of the filtration cloth 11, from where they are removed by means of doctor blades 14 or the like into a discharge chute 15 before the next cycle of filtration.

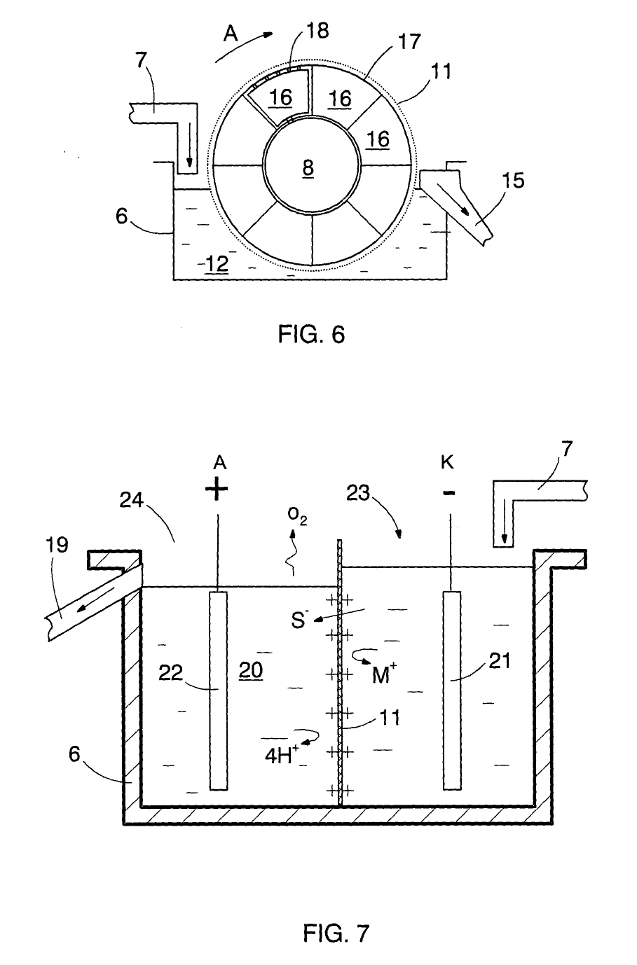

FIG. 6 shows the principle of a drum filter, which differs from the disc filter in that the outer circumference of the frame part 8 is provided with hollow longitudinal spaces 16, the outer circumference of which acts as a filter surface 17. The filter surface is provided with openings 18. The filtration cloth 11 is arranged on the outer circumference of the drum filter. In the figure, the filtration cloth 11 is denoted by a broken line for the sake of clarity. The drum filter is rotated in direction A around its longitudinal axis in a basin containing a mixture 12 to be treated. A solids cake formed on the surface of the filtration cloth is removed by means of a pressure pulse into a discharge chute 15 before the next cycle of filtration.

FIG. 7 shows the principle of an electrolytic process. An electrolytic process includes a basin 6, to which an electrolytic solution is supplied from a feed pipe 7. Some of the solution correspondingly leaves the basin via a discharge conduit 19. A negative electrode or cathode 21 and a positive electrode or anode 22 have been immersed in the electrolytic solution 20 contained in the basin 6. A dense filtration cloth 11 according to the invention is arranged between the anode and the cathode in the electrolytic solution 20, and the cloth constitutes a flow resistance to the electrolyte flowing from a cathode chamber 23 to an anode chamber 24. Therefore the surface is higher in the cathode chamber 23 than in the anode chamber 24. Since the filtration cloth 11 has been treated so as to become electrically conductive according to the invention, it does not provide insulation between the cathode and the anode in the manner of the prior art filtration cloths, and therefore the consumption of energy supplied to the electrodes can be reduced. For example in a process for refining metals, the feed solution is a saline solution of silver, nickel, manganese or some other corresponding precious metal. In the arrangement shown in the figure, the feed solution is conducted from the feed pipe 7 to the cathode chamber 23, where it is subjected to an electric field. The desired component is thus reduced to a cathode, while undesirable components are applied through the filtration cloth 11 to the anode chamber. In the anode chamber 24, the undesirable components are guided via a discharge conduit 19 to removal of impurities and further to liquid circulation. The electrically conductive filtration cloth 11 according to the invention has a residual electric charge, wherefore it acts as an at least partly selective ion exchanger. In order that the filtration cloth can filter ions, the openings of the cloth must be small enough. If the openings are large, there will be such a high flow of the feed solution from the cathode chamber 23 to the anode chamber 24 through the filtration cloth 11 that the permanent electrical charge of the cloth will not be able to affect movements of ions. In such a case a permanent electrical charge is not of essential significance. The base fabric of the filtration cloth according to the invention has been woven into as dense a structure as possible, whereafter the size of the openings on the cloth has been further reduced by the polymer treatment to achieve a desired size. A filtration cloth with a residual electric charge is provided with either a negative or a positive electric charge, depending on how the filtration cloth has been arranged in the electrolytic process. In the situation shown in the FIG. 7, the filtration cloth 11 has a positive charge, which, as is well known, attracts negatively charged ions and correspondingly repels positively charged ions. In such a case a positively charged filtration cloth repels positively charged metal ions M⁺ in the cathode chamber 23, and correspondingly attracts negatively charged ions S⁻. In the anode chamber 24 the positively charged filtration cloth 11 repels positively charged ions H⁺. In such a manner a filtration cloth with a permanent electrical charge can improve the yield of desired metal ions and facilitate the removal of undesirable ions from the process. Furthermore, due to the dense filtration cloth there is a lower flow of the electrolyte than previously, and the solution cycle of the electrolytic process can thus be smaller. As a result, the electrolytic equipment can be smaller and the energy consumption thereof will be lower due to less need for pumping, for example.

The electrolytic process shown in FIG. 7 includes the following processes:

Anode reaction: 2H₂O→O₂+4H⁺+4e⁻

Cathode reaction: M⁺+e⁻→M

The drawings and the related description are only intended to illustrate the inventive idea. The details of the invention can vary within the scope of the claims.

What is claimed is:

1. A solid-liquid filtration cloth comprising
a base fabric woven from machine direction and cross direction yarns of a polymer material,
and wherein the base fabric has been treated after the weaving by a polymer material, which has better electric conductivity than the yarns of the base fabric,
and a coating of said electrically conductive polymer material provided at least on one side of the base fabric.

2. A solid-liquid filtration cloth according to claim 1, wherein substantially all the yarns of the base fabric comprise a coating of said electrically conductive polymer material.

3. A solid-liquid filtration cloth according to claim 1, wherein said polymer material is based on polyaniline.

4. A solid-liquid filtration cloth according to claim 1, wherein said polymer material is based on polypyrrole.

5. A solid-liquid filtration cloth according to claim 1, wherein the filtration cloth has water permeability in the range of 10 to 200 l/m²/h and surface resistance of less than 1*10⁷ ohm.

6. A solid-liquid filtration cloth according to claim 1, wherein the size of openings in the filtration cloth varies between 0.2 and 50 micrometers.

7. A solid-liquid filtration cloth according to claim 1, wherein the filtration cloth is provided with a permanent electrical charge resulting from the structure of the cloth.

8. A solid-liquid filtration cloth according to claim 1, wherein the filtration cloth is arranged as a part of electrolytic equipment.

9. A solid-liquid filtration cloth according to claim 1, wherein the filtration cloth is arranged against a filter surface of a mechanical filter apparatus.

10. A solid-liquid filtration cloth according to claim 1, wherein the filtration cloth is hydrophilic.
